(19) United States
(12) Patent Application Publication
(10) Pub. No.: US 2024/0185052 A1
(43) Pub. Date: Jun. 6, 2024

(54) PROPRIOCEPTIVE LEARNING

(71) Applicant: Honda Motor Co., Ltd., Tokyo (JP)

(72) Inventors: Alireza REZAZADEH, Minneapolis, MN (US); Nawid JAMALI, Dublin, CA (US); Soshi IBA, Mountain View, CA (US)

(21) Appl. No.: 17/972,854

(22) Filed: Oct. 25, 2022

(51) Int. Cl. G06N 3/08; G06K 9/62

(52) U.S. Cl. CPC G06N 3/08; G06K 9/6232; G06K 9/6296

(57) ABSTRACT

According to one aspect, a robot for proprioceptive learning may include a set of sensors, a memory, and a processor. The processor may perform receiving a set of sensor reading data from the set of sensors, receiving a set of sensor position data associated with the set of sensors, constructing a first graph representation based on the set of sensor reading data, constructing a second graph representation based on the set of sensor position data, performing message passing operation between nodes of the first graph representation and the second graph representation to update the first graph representation and the second graph representation, and executing a task based on readouts from the updated first graph representation and the updated second graph representation.

### BACKGROUND

Proprioception is generally mediated by proprioceptors, mechanosensory neurons located within muscles, tendons, and joints. While animals may possess multiple subtypes of proprioceptors, which detect distinct kinematic parameters, such as joint position, movement, and load, robots do not have such mechanosensory neurons.

### BRIEF DESCRIPTION

According to one aspect, a system for proprioceptive learning may include a memory and a processor. The memory may store one or more instructions. The processor may execute one or more of the instructions stored on the memory to perform one or more acts, actions, or steps, such as receiving a set of sensor reading data from a set of sensors, receiving a set of sensor position data associated with the set of sensors, constructing a first graph representation based on the set of sensor reading data, constructing a second graph representation based on the set of sensor position data, performing message passing operation between nodes of the first graph representation and the second graph representation to update the first graph representation and the second graph representation, and executing a task based on readouts from the updated first graph representation and the updated second graph representation.

The set of sensors may include a force sensor, a temperature sensor, a pressure sensor, a tactile sensor, or an image capture sensor. The processor may perform feature extraction to generate point cloud positions and feature embeddings based on the set of sensor reading data. The processor may construct the first graph representation based on the point cloud positions and the feature embeddings or sensory reading embeddings. The first graph representation may be a world graph indicative of points from an object point cloud of an object in contact with at least some of the set of sensors at a time step. The second graph representation may be a body graph indicative of a geometric arrangement associated with the set of sensors at a time step. The task may be a pose estimation task or a stability prediction task. The performing the message passing operation between nodes of the first graph representation and the second graph representation may be based on a hierarchical graph neural network (GNN). The processor may perform multiple rounds of message passing operation between nodes of the first graph representation and the second graph representation to update the first graph representation and the second graph representation.

The system for proprioceptive learning may include the set of sensors that receive the set of sensor reading data. The system for proprioceptive learning may include one or more actuators executing the task based on the readouts.

According to one aspect, a computer-implemented method for proprioceptive learning may include receiving a set of sensor reading data from a set of sensors, receiving a set of sensor position data associated with the set of sensors, constructing a first graph representation based on the set of sensor reading data, constructing a second graph representation based on the set of sensor position data, performing message passing operation between nodes of the first graph representation and the second graph representation to update the first graph representation and the second graph representation, and executing a task based on readouts from the updated first graph representation and the updated second graph representation.

The computer-implemented method for proprioceptive learning may include performing feature extraction to generate point cloud positions and feature embeddings based on the set of sensor reading data and constructing the first graph representation based on the point cloud positions and the feature embeddings. The first graph representation may be a world graph indicative of points from an object point cloud of an object in contact with at least some of the set of sensors at a time step. The second graph representation may be a body graph indicative of a geometric arrangement associated with the set of sensors at a time step. The task may be a pose estimation task or a stability prediction task. The computer-implemented method for proprioceptive learning may include performing the message passing operation between nodes of the first graph representation and the second graph representation based on a hierarchical graph neural network (GNN).

According to one aspect, a robot for proprioceptive learning may include a set of sensors, a memory, and a processor. The processor may execute one or more of the instructions stored on the memory to perform one or more acts, actions, or steps, such as receiving a set of sensor reading data from the set of sensors, receiving a set of sensor position data associated with the set of sensors, constructing a first graph representation based on the set of sensor reading data, constructing a second graph representation based on the set of sensor position data, performing message passing operation between nodes of the first graph representation and the second graph representation to update the first graph representation and the second graph representation, and executing a task based on readouts from the updated first graph representation and the updated second graph representation.

The set of sensors may include a force sensor, a temperature sensor, a pressure sensor, a tactile sensor, or an image capture sensor. The processor may perform feature extraction to generate point cloud positions and feature embeddings based on the set of sensor reading data. The processor may construct the first graph representation based on the point cloud positions and the feature embeddings. The first graph representation may be a world graph indicative of points from an object point cloud of an object in contact with at least some of the set of sensors at a time step.

### BRIEF DESCRIPTION OF THE DRAWINGS

FIG. 1 is an exemplary component diagram of a system for proprioceptive learning, according to one aspect.

FIG. 2 is an exemplary flow diagram of a computer-implemented method for proprioceptive learning, according to one aspect.

FIG. 3 is an illustration of an exemplary architecture associated with the system for proprioceptive learning of FIG. 1, according to one aspect.

FIG. 4 is an illustration of an exemplary graph networks associated with proprioceptive learning, according to one aspect.

FIG. 5 is an illustration of an exemplary message passing operations associated with proprioceptive learning, according to one aspect.

FIG. 6 is an illustration of an example computer-readable medium or computer-readable device including processor-executable instructions configured to embody one or more of the provisions set forth herein, according to one aspect.

FIG. 7 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a bus that interconnects components inside a vehicle or a robot using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “robot system”, as used herein, may be any automatic or manual systems that may be used to enhance a robot, and/or associated operations. Exemplary robot systems include an autonomous operation system, an electronic stability control system, an anti-lock brake system, a brake assist system, an automatic brake prefill system, a low speed follow system, a cruise control system, a collision warning system, a collision mitigation braking system, a cruise control system, a lane departure warning system, a blind spot indicator system, a lane keep assist system, a navigation system, a transmission system, brake pedal systems, an electronic power steering system, visual devices (e.g., camera systems, proximity sensor systems), a monitoring system, a suspension system, a lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

A hierarchical graph neural network architecture to learn rich proprioceptive representation of multi-modal tactile information is discussed herein. With this formulation, the structure of the environment may be fully exploited by learning a graph representation for an object surface and a graph representation for an associated robotic arm which may be hierarchically connected. This hierarchical connection may enable for the flow of information between the object and the robot and may enable learning rich multi-modal data representation that may be used in various robotic tasks.

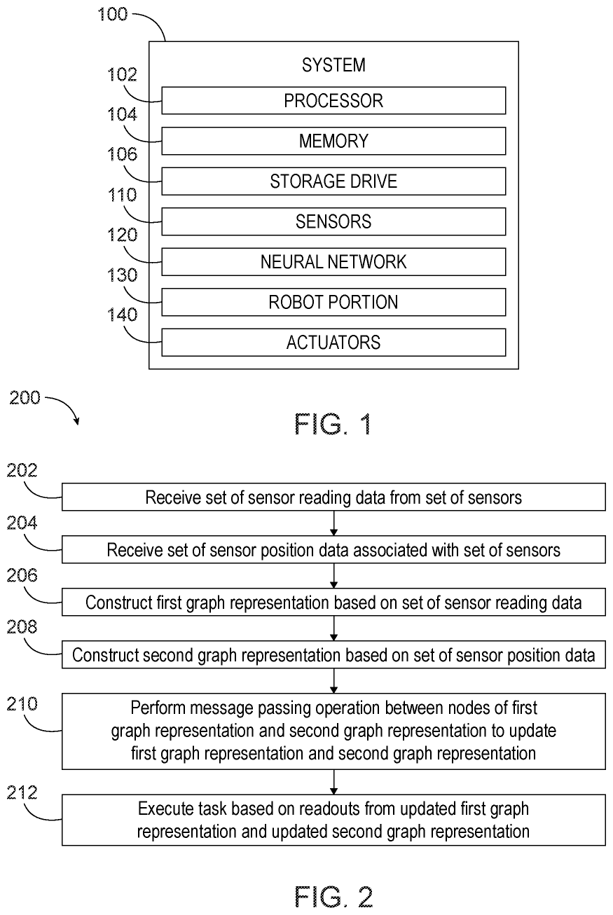

FIG. 1 is an exemplary component diagram of a system 100 for proprioceptive learning, according to one aspect. The system 100 for proprioceptive learning may include a processor 102, a memory 104, a storage drive 106, one or more sets of sensors 110, a neural network 120, a robot portion 130, and one or more actuators 140. The memory 104 may store one or more instructions. The processor 102 may execute one or more of the instructions stored on the memory 104 to perform one or more acts, actions, or steps.

The system 100 for proprioceptive learning may include the set of sensors 110 that receive the set of sensor reading data. For example, the processor 102 may receive a set of sensor reading data from the set of sensors 110. Through robotic interaction, the sensors collect multimodal sensory information such as force, pressure, and temperature. The set of sensors 110 may include any type of sensor, such as a force sensor, a temperature sensor, a pressure sensor, a tactile sensor, or an image capture sensor.

The processor 102 may perform feature extraction to generate point cloud positions and feature embeddings based on the set of sensor reading data. In this way, the inputs to the system may include tow or more different modalities, such as the point cloud coordinates from the set of sensors 110 and the sensor reading data. The system 100 for proprioceptive learning may learn the representation of the sensor reading data or the sensory data by factoring in the proprioceptive signal. In other words, system 100 for proprioceptive learning may learn the representation or the meaning of the sensory data by considering the location of each sensor of the set of sensors 110 and how each sensor is connected to the system or robot portion 130.

Additionally, the processor 102 may receive a set of sensor position data associated with the set of sensors 110.

According to one aspect, the processor 102 may construct a first graph representation based on the set of sensor reading data. Each node in this graph may be connected to the neighboring nodes within a fixed radius. The processor 102 may construct the first graph representation based on the 3-dimensional (3D) point cloud positions and the feature embeddings from the feature extraction. The first graph representation may be a world graph indicative of points from an object point cloud of an object in contact with at least some of the set of sensors 110 at a time step. Edge embeddings in the world graph may be also set to the relative spatial distance of the connecting nodes. The spatial coordinates of points along with their feature vectors may be encoded into the world graph node embeddings. According to one aspect, object surface point clouds may be obtained from vision-based tactile readings. Further, the processor 102 may determine whether the sensor is in contact with an object via a soft touch or a hard touch. The first graph representation or the world graph may include a plurality of nodes. Each node of the first graph representation or the world graph may represent points from the point cloud.

The processor 102 may construct a second graph representation based on the set of sensor position data, which may include the 3D coordinates of the sensors (e.g., the position of the sensors in 3D space). The second graph representation may be a body graph indicative of a geometric arrangement associated with the set of sensors 110 at a time step. The second graph representation or the body graph may also include a plurality of nodes. The body graph nodes may represent each sensor on the robotic end-effector. Positional coordinates of each sensor may be encoded to its corresponding node in the body graph. Connectivity of the body graph follows the same logic as the world graph where each node may be connected if close than a predetermined threshold. Each node of the second graph representation or the body graph may positionally represent each sensor from the set of sensors 110. Since the robot portion 130 may change positions or move, the second graph representation may change across different time steps, while the first graph representation may change across different time steps as each sensor receives new sensor readings.

The body and world graphs may be also connected by world-body edges such that each sensor in the body graph may be linked to all its associated point cloud nodes in the world graph.

The graph construction may be performed based on an assumption that there is an edge or there is a connectivity between a given node of the sensor and all of the points in the sensor point cloud readings. In other words, whatever the sensor is reading, may be assumed to be connected through some edge connection to that specific node that corresponds to that sensor in the body graph.

The processor 102 may initialize embeddings for each of these two graph representations. For the world graph, the initial embeddings of each node may be the point cloud features. For the body graph, the initial feature embeddings of each node may be the sensor modality embeddings, which encapsulate the sensor readings into a lower dimensional space.

After the first graph representation and the second graph representation are constructed, the processor 102 may build a hierarchy of the two different graphs that are interconnected. Correspondence between each node in the world graph may be known as each point in the point graph, and correspondence between each node in the body graph may be known as each sensor. This correspondence enables the system 100 for proprioceptive learning to examine or analyze where in the world the sensor data was produced. If the proprioceptive data or the location of these particular sensors are included in the graph representation, the processor 102 may connect or incorporate proprioceptive information into the data. The nodes of the second graph representation may be the known locations of the sensors. This may be provided as design information or provided via a schematic of the robot. The nodes of the first graph representation may be sensor outputs generated by each sensor and connected to corresponding nodes of the second graph representation by location.

The processor 102 may perform a message passing operation in a graph neural network (GNN) framework 120 between nodes of the first graph representation and the second graph representation to update the first graph representation and the second graph representation. The performing the message passing operation between nodes of the first graph representation and the second graph representation may be based on a hierarchical GNN and may enable the nodes to exchange information. The processor 102 may perform multiple rounds of message passing operation between nodes of the first graph representation and the second graph representation to update the first graph representation and the second graph representation.

And after the rounds of message passing operations, the information may flow from the body graph into the world graph and/or from the world graph into the body graph. Through this back and forth of information, each node embedding may be updated with information regarding the input data. Thereafter, the processor 102 may take a readout of each node or representation and use the readout(s) in some downstream task, such as pose estimation or graph disability prediction, or other robotic task. According to one aspect, the readouts from each graph representation may be concatenated and passed to another neural network, such as a classifier network. In this way, the processor 102 may execute a task based on readouts from the updated first graph representation and the updated second graph representation. The task may be a pose estimation task, a stability prediction task, an object protrusion prediction task, a movement task, or other robotic task.

The data representation may be learned through multiple rounds of hierarchical message passing operations that update the graph embeddings. First, world and body graphs may individually perform message passing inside. Following that, world-to-body and body-to-world message passing may be performed between world and body graphs through the world-body edges. This hierarchical message passing mechanism may flow the information between the world and body graphs and enhance the data representation learning. Finally, the updated node embeddings may be extracted from each graph and used in downstream tasks such as pose estimation, grasp stability prediction, etc.

The system 100 for proprioceptive learning may include one or more actuators 140 executing the task based on the readouts or updated embeddings from the nodes of the respective graphical representations. In this regard, the system 100 for proprioceptive learning may be implemented as a robot for proprioceptive learning.

One benefit of the GNN framework 120 implemented in the systems and techniques for proprioceptive learning is that the GNN framework 120 disclosed herein consider sensor geometry during the message passing operations. The framework provided herein exploits the known structure of the environment to learn the data representation from observations. The sensor spatial relations together with their sensory readings may provide rich inductive bias about the data generation process which enhances the representation learning problem.

The framework provided herein may be utilized to learn rich proprioceptive representation of sensor information that accounts for the geometry of robotic hand. The framework may take as input, multimodal tactile sensor readings (e.g., force, pressure, and temperature) and build two or more complementary graph representations including the world graph that captures the object surface geometry and the body graph that captures the geometric arrangement of the tactile sensors on the robotic end-effector. These two graph representations communicate in a hierarchical manner and extract and exchange information to learn a proprioceptive representation of the tactile data. The learned or updated representation may be a rich abstraction of the proprioceptive multimodal tactile sensor readings and their relations that can be used in downstream robotic tasks such as making predictions on grasp stability, object pose, object 3D geometry, and object dynamics.

FIG. 2 is an exemplary flow diagram of a computer-implemented method 200 for proprioceptive learning, according to one aspect. The computer-implemented method for proprioceptive learning may include receiving 202 a set of sensor reading data from a set of sensors 110, receiving 204 a set of sensor position data associated with the set of sensors 110, constructing 206 a first graph representation based on the set of sensor reading data, constructing 208 a second graph representation based on the set of sensor position data, performing 210 message passing operation between nodes of the first graph representation and the second graph representation to update the first graph representation and the second graph representation, and executing 212 a task based on readouts from the updated first graph representation and the updated second graph representation.

Additionally, the computer-implemented method 200 for proprioceptive learning may include performing feature extraction to generate point cloud positions and feature embeddings based on the set of sensor reading data and constructing the first graph representation based on the point cloud positions and the feature embeddings. The first graph representation may be a world graph indicative of points from an object point cloud of an object in contact with at least some of the set of sensors 110 at a time step. The second graph representation may be a body graph indicative of a geometric arrangement associated with the set of sensors 110 at a time step. The task may be a pose estimation task or a stability prediction task. The computer-implemented method for proprioceptive learning may include performing the message passing operation between nodes of the first graph representation and the second graph representation based on the GNN framework 120, which may be hierarchical.

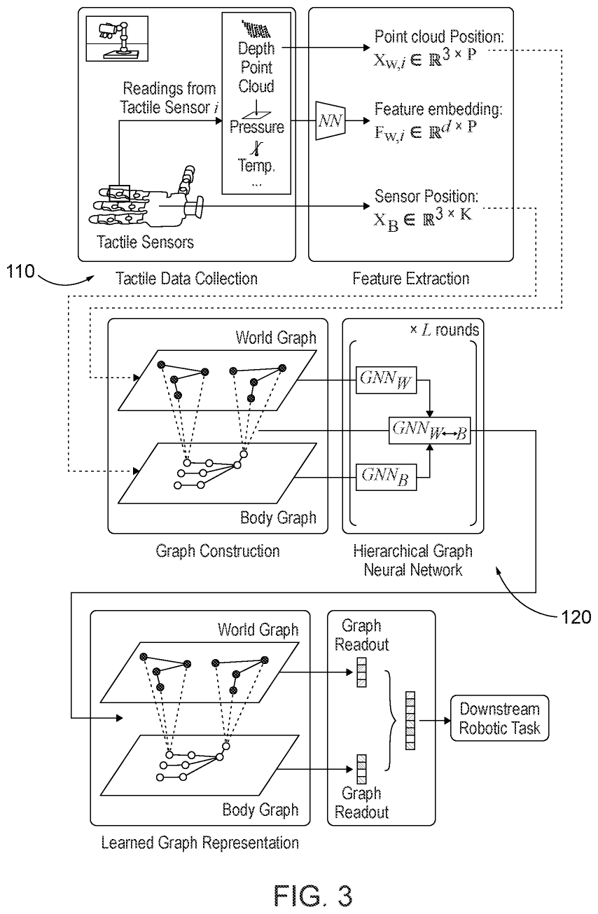

FIG. 3 is an illustration of an exemplary architecture associated with the system 100 for proprioceptive learning of FIG. 1, according to one aspect. Here, a hierarchical GNN framework for learning proprioceptive tactile data representation is provided. During data collection, sensors 110 may receive sensor data or readings from different types of sensors which may include depth point cloud data, pressure data, temperature data, etc. Feature extraction may be performed on the depth point cloud to provide a point cloud position X_{W,i}∈ [symbol] ^{3×P}. A feature encoder may perform feature embedding during feature extraction on the sensor data to generate feature embedding data F_{W,i}∈ [symbol] ^{d×P}. The sensor positioning may be provided or determined as X_{B}∈ [symbol] ^{3×K}. The point cloud position and feature embedding may be utilized to generate the world graph and the sensor position may be utilized to generate the body graph during graph construction. The GNN framework 120 may be utilized to perform L rounds of message passing operations via GNN_{W},GNN_{W⇄B},GNN_{B}. After the message passing operations, graph readouts may be taken from the world graph and the body graph, and these readouts may be concatenated. Thereafter, a downstream robotic task may be performed based on or using the readout as an input.

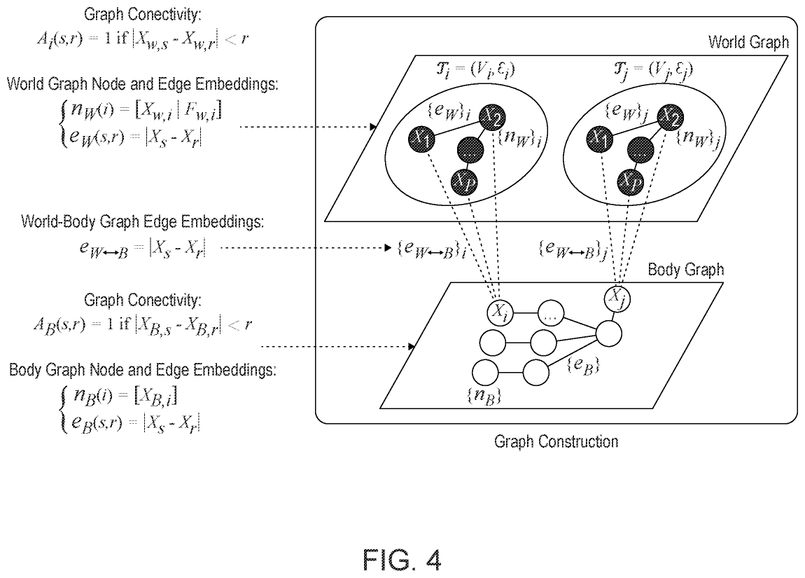

FIG. 4 is an illustration of an exemplary graph networks associated with proprioceptive learning, according to one aspect. In FIG. 4, graph construction may occur according to:

$$Graph Connectivity , World : {A}_{i} ( s , r ) = 1 if \vert {X}_{W , s} - {X}_{W , r} \vert < r$$

$$World Graph Node and Edge Embeddings : \{ \begin{matrix}{n}_{W} ( i ) = [ {X}_{W , i} \vert {F}_{W , i} ] \\ {e}_{W} ( s , r ) = [ {X}_{s} - {X}_{r} ]\end{matrix}$$

$$World - Body Graph Edge Embeddings : {e}_{W ↔ B} = \vert {X}_{s} - {X}_{r} \vert$$

$$Graph Connectivity , Body : {A}_{B} ( s , r ) = 1 if \vert {X}_{B , s} - {X}_{B , r} \vert < r$$

$$Body Graph Node and Edge Embeddings : \{ \begin{matrix}{n}_{B} ( i ) = [ {X}_{B , i} ] \\ {e}_{B} ( s , r ) = [ {X}_{s} - {X}_{r} ]\end{matrix}$$

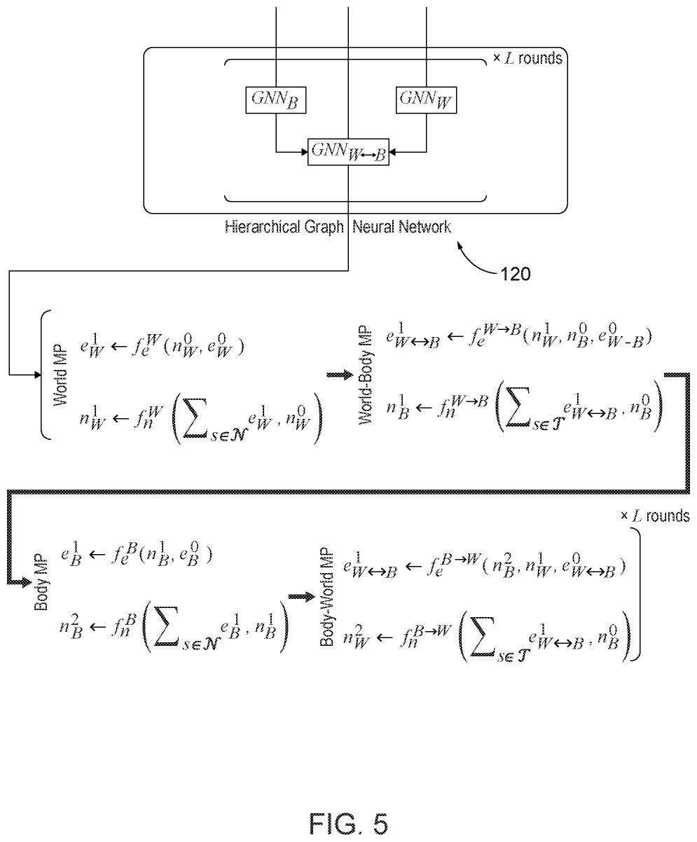

FIG. 5 is an illustration of an exemplary message passing operations associated with proprioceptive learning, according to one aspect. Here, message passing operations are described.

$${( world {MP}_{{n}_{W}^{1} ← {f}_{n}^{W} ( {\sum }_{s ∈ 𝒩} {e}_{W}^{1} , {n}_{W}^{0} )}^{{e}_{W}^{1} ← {f}_{e}^{W} ( {n}_{W}^{0} , {e}_{W}^{0} )} \to world - body {MP}_{{n}_{B}^{1} ← {f}_{n}^{W \to B} ( {\sum }_{s ∈ 𝒯} {e}_{W ↔ B}^{1} , {n}_{B}^{0} )}^{{e}_{W ↔ B}^{1} ← {f}_{e}^{W \to B} ( {n}_{W}^{1} , {n}_{B}^{0} , {e}_{W - B}^{0} )} \to body {MP}_{{n}_{B}^{2} ← {f}_{n}^{B} ( {\sum }_{s ∈ 𝒩} {e}_{B}^{1} , {n}_{B}^{1} )}^{{e}_{B}^{1} ← {f}_{e}^{B} ( {n}_{B}^{1} , {e}_{B}^{0} )} \to \\ body - world {MP}_{{n}_{W}^{2} ← {f}_{n}^{B \to W} ( {\sum }_{s ∈ 𝒯} {e}_{W ↔ B}^{1} , {n}_{B}^{0} )}^{{e}_{W ↔ B}^{1} ← {f}_{e}^{B \to W} ( {n}_{B}^{2} , {n}_{W}^{1} , {e}_{W ↔ B}^{0} )} )}^{\times L rounds}$$

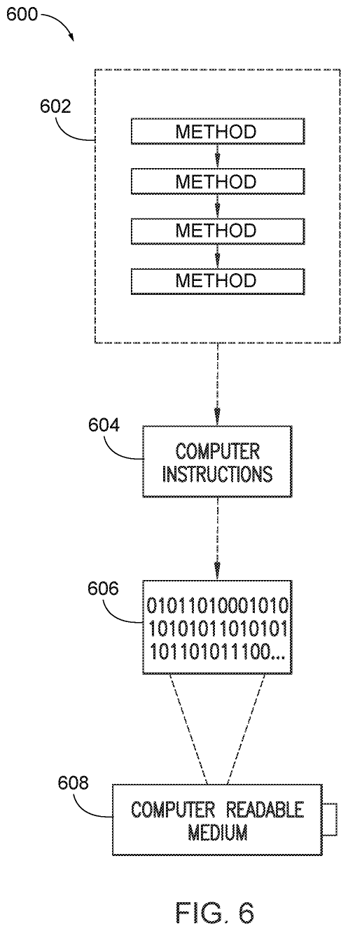

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the computer-implemented method 200 of FIG. 2. In another aspect, the processor-executable computer instructions 604 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

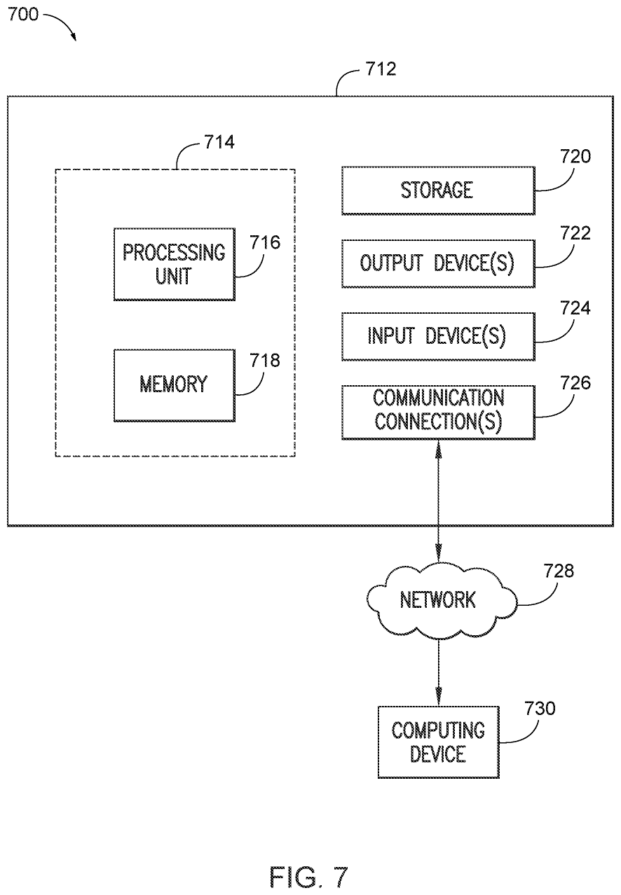

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including a computing device 712 configured to implement one aspect provided herein. In one configuration, the computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by the at least one processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A system for proprioceptive learning, comprising:
a memory storing one or more instructions;
a processor executing one or more of the instructions stored on the memory to perform:
receiving a set of sensor reading data from a set of sensors;
receiving a set of sensor position data associated with the set of sensors;
constructing a first graph representation based on the set of sensor reading data;
constructing a second graph representation based on the set of sensor position data;
performing message passing operation between nodes of the first graph representation and the second graph representation to update the first graph representation and the second graph representation; and
executing a task based on readouts from the updated first graph representation and the updated second graph representation.

2. The system for proprioceptive learning of claim 1, wherein the set of sensors includes a force sensor, a temperature sensor, a pressure sensor, a tactile sensor, or an image capture sensor.

3. The system for proprioceptive learning of claim 1, wherein the processor performs feature extraction to generate point cloud positions and feature embeddings based on the set of sensor reading data and wherein the processor constructs the first graph representation based on the point cloud positions and the feature embeddings.

4. The system for proprioceptive learning of claim 1, wherein the first graph representation is a world graph indicative of points from an object point cloud of an object in contact with at least some of the set of sensors at a time step.

5. The system for proprioceptive learning of claim 1, wherein the second graph representation is a body graph indicative of a geometric arrangement associated with the set of sensors at a time step.

6. The system for proprioceptive learning of claim 1, wherein the task is a pose estimation task or a stability prediction task.

7. The system for proprioceptive learning of claim 1, comprising the set of sensors that receive the set of sensor reading data.

8. The system for proprioceptive learning of claim 1, comprising one or more actuators executing the task based on the readouts.

9. The system for proprioceptive learning of claim 1, wherein the performing the message passing operation between nodes of the first graph representation and the second graph representation is based on a hierarchical graph neural network (GNN).

10. The system for proprioceptive learning of claim 1, wherein the processor performs multiple rounds of message passing operation between nodes of the first graph representation and the second graph representation to update the first graph representation and the second graph representation.

11. A computer-implemented method for proprioceptive learning, comprising:
receiving a set of sensor reading data from a set of sensors;
receiving a set of sensor position data associated with the set of sensors;
constructing a first graph representation based on the set of sensor reading data;
constructing a second graph representation based on the set of sensor position data;
performing message passing operation between nodes of the first graph representation and the second graph representation to update the first graph representation and the second graph representation; and
executing a task based on readouts from the updated first graph representation and the updated second graph representation.

12. The computer-implemented method for proprioceptive learning of claim 11, comprising:
performing feature extraction to generate point cloud positions and feature embeddings based on the set of sensor reading data; and
constructing the first graph representation based on the point cloud positions and the feature embeddings.

13. The computer-implemented method for proprioceptive learning of claim 11, wherein the first graph representation is a world graph indicative of points from an object point cloud of an object in contact with at least some of the set of sensors at a time step.

14. The computer-implemented method for proprioceptive learning of claim 11, wherein the second graph representation is a body graph indicative of a geometric arrangement associated with the set of sensors at a time step.

15. The computer-implemented method for proprioceptive learning of claim 11, wherein the task is a pose estimation task or a stability prediction task.

16. The computer-implemented method for proprioceptive learning of claim 11, comprising performing the message passing operation between nodes of the first graph representation and the second graph representation based on a hierarchical graph neural network (GNN).

17. A robot for proprioceptive learning, comprising:
a set of sensors;
a memory storing one or more instructions;
a processor executing one or more of the instructions stored on the memory to perform:
receiving a set of sensor reading data from the set of sensors;
receiving a set of sensor position data associated with the set of sensors;
constructing a first graph representation based on the set of sensor reading data;
constructing a second graph representation based on the set of sensor position data;
performing message passing operation between nodes of the first graph representation and the second graph representation to update the first graph representation and the second graph representation; and
executing a task based on readouts from the updated first graph representation and the updated second graph representation.

18. The robot for proprioceptive learning of claim 17, wherein the set of sensors includes a force sensor, a temperature sensor, a pressure sensor, a tactile sensor, or an image capture sensor.

19. The robot for proprioceptive learning of claim 17, wherein the processor performs feature extraction to generate point cloud positions and feature embeddings based on the set of sensor reading data and wherein the processor constructs the first graph representation based on the point cloud positions and the feature embeddings.

20. The robot for proprioceptive learning of claim 17, wherein the first graph representation is a world graph indicative of points from an object point cloud of an object in contact with at least some of the set of sensors at a time step.
